(19) United States
(12) Patent Application Publication
(10) Pub. No.: US 2026/0212647 A1
(43) Pub. Date: Jul. 23, 2026

(54) DEVICE, METHOD, SYSTEM, AND STORAGE MEDIUM FOR DETECTING SMALL OBJECTS UNDER COMPLEX SCENARIOS

(71) Applicants: XUZHOU HIGH TECH ZONE SAFETY EMERGENCY EQUIPMENT INDUSTRIAL TECHNOLOGY RESEARCH INSTITUTE, Xuzhou (CN); CHINA UNIVERSITY OF MINING AND TECHNOLOGY, Xuzhou (CN)

(72) Inventors: Xiao YU, Xuzhou (CN); Shaohua LEI, Xuzhou (CN); Fei DONG, Xuzhou (CN); Meng WANG, Xuzhou (CN); Chong LI, Xuzhou (CN); Zhengzheng TANG, Xuzhou (CN); Shiyuan ZHANG, Xuzhou (CN)

(21) Appl. No.: 19/218,261

(22) Filed: May 24, 2025

Related U.S. Application Data
(63) Continuation of application No. PCT/CN2025/078725, filed on Feb. 24, 2025.

(30) Foreign Application Priority Data
Jan. 22, 2025 (CN) 202510098099.1

(51) Int. Cl. G06V 10/764; G06V 10/40; G06V 10/80; G06V 10/82

(52) U.S. Cl. CPC G06V 10/764; G06V 10/40; G06V 10/806; G06V 10/82

(57) ABSTRACT

A device for detecting small objects under complex scenarios is provided. The device includes: an adaptive enhancement module used for carrying out an adaptive enhancement pretreatment on low-quality images in images containing complex small objects, and carrying out a feature extraction enhancement on key features of different types of objects; a feature extraction module used for adaptively excavating multi-scale feature maps representing key features of the small object from an enhanced image; a feature fusion module used for fusing a shallow feature maps containing detailed information of the object and deep feature maps containing category semantic information according to multi-scale features obtained from the feature extraction module; and a prediction module used for classifying and positioning the object according to a fused feature map obtained from the feature fusion module.

### CROSS-REFERENCE TO RELATED APPLICATIONS

This application is a continuation of PCT/CN2025/078725, filed on Feb. 24, 2025 and claims priority of Chinese Patent Application No. 202510098099.1, filed on Jan. 22, 2025, the entire contents of which are incorporated herein by reference.

### TECHNICAL FIELD

The disclosure belongs to the technical field of object detection, and particularly relates to a device, a method, a system and a storage medium for detecting small objects under complex scenarios.

### BACKGROUND

With rapid development of computer vision technology, object detection has become a core task in this field. Object detection not only needs to locate all the objects in an image, but also needs to identify categories of each object. In recent years, thanks to progress of deep learning technology, object detection algorithms have achieved significant breakthroughs in both accuracy and speed. However, in practical application, we often face a challenge of complex small object detection. Small objects usually refer to objects occupying a small pixel area in the image, such as vehicles in remote sensing images, pedestrians in surveillance videos or animals in field images, surface defects of industrial products, and various complex objects in coal mines. Because of an uneven scale of small objects, irregular visual features and small area in the image, when the environment is complex, lighting conditions are poor and the image quality is low, it is often accompanied by complex background interference, object occlusion and other problems. In this case, small object detection is more difficult than general object detection.

At present, the algorithms applied to the object detection can be mainly divided into two categories: single-stage and two-stage object detection algorithms. The single-stage object detection algorithm usually has advantages of high speed, simplicity, easy deployment and high real-time. This algorithm is capable of simultaneously performing bounding box regression and classification prediction tasks, achieving end-to-end object detection. The classical single-stage object detection algorithm mainly includes a YOLO (You Only Look Once) series algorithm and an SSD (Single Shot Detector) series algorithm. The two-stage object detection algorithm has two stages: a candidate frame generation and a fine classification adjustment. It can achieve higher accuracy in object location and classification, and it is easier to deal with multi-scale objects. However, the two-stage method often has disadvantages of high complexity, difficult deployment and not suitable for high real-time applications. The classical two-stage object detection algorithms mainly include an R-CNN (Region with CNN feature) series and a Faster R-CNN series of algorithms. In view of a demand for detection and location of complex small objects in many industrial scenarios, the object detection algorithm has higher requirements for high precision, high speed and easy deployment in equipment with limited computing resources. Therefore, the single-stage object detection algorithm has more advantages than the two-stage object detection algorithm. In recent years, with continuous development of YOLO network, many researchers have designed object detection models for different scenarios based on the YOLO network. However, for detection methods of the complex small objects, these methods face challenges not only from large parameters of an algorithm model, long reasoning time, and unsatisfactory false detection and missed detection rates, but also from environmental interference susceptibility and difficulties in feature extraction due to imbalanced small-object scales, lack of distinct visual features, and irregular shapes.

### SUMMARY

The technical problem to be solved by the disclosure is to provide a device, a method, a system and a storage medium for detecting small objects which can adapt to different complex scenarios.

In order to achieve the above purpose, the disclosure adopts following technical schemes.

A device for detecting small objects under complex scenarios includes:
an adaptive enhancement module, where the adaptive enhancement module is used for carrying out an adaptive enhancement pretreatment on low-quality images in images containing complex small objects, and carrying out a feature extraction enhancement on key features of different types of objects;
a feature extraction module, where the feature extraction module is used for adaptively excavating multi-scale feature maps representing key features of a small object from an enhanced image;
a feature fusion module, where the feature fusion module is used for fusing shallow feature maps containing detailed information of the object and deep feature maps containing category semantic information according to multi-scale features obtained from the feature extraction module; and
a prediction module, where the prediction module is used for classifying and positioning the object according to the fused feature maps obtained from the feature fusion module.

Optionally, the feature extraction module is constructed based on a designed DSC_Attention module, a two-dimensional convolution module Conv, a dynamic snake convolution module DySC, an Attention module and an SPP module, where an attention mechanism embedded in the DSC_Attention module and the Attention module adopts an optimal attention mechanism adaptive embedding strategy based on deep reinforcement learning, and an initial default embedded attention mechanism module is a CPCA attention mechanism module.

Optionally, the adaptive enhancement modules include: 1) a deep reinforcement learning-based adaptive enhancement network for low-quality images, and 2) a feature extraction adaptive enhancement module of the multi-attention mechanism adaptively embedded network based on heatmaps and Double Deep Q-Network (DDQN).

Optionally, the feature fusion module includes three DySC modules, six DSCSP modules, six SDFM modules and three Upsample modules, where a bottom-up fusion path of the feature fusion module includes following steps: three SDFM modules are placed on L13, L16 and L19 layers respectively; three DSCSP modules are placed on L14, L17 and L20 layers behind the three SDFM modules; L12, L15 and L18 are Upsample modules; and a top-down path includes three groups of same module structures: L21-L23 layers are constructed by one DySC module, one SDFM module and one DSCSP module, and L24-L26 layers and L27-L29 layers are also constructed in the same way.

The disclosure also provides a method for detecting the small objects under the complex scenarios, including following steps:
the adaptive enhancement module is used for carrying out the adaptive enhancement pretreatment on the low-quality images in the images containing the complex small objects, and carrying out the feature extraction enhancement on the key features of the different types of the objects;
the feature extraction module is used for adaptively excavating the multi-scale feature maps representing the key features of the small object from the enhanced image;
the feature fusion module is used for fusing the shallow feature maps containing the detailed information of the object and the deep feature maps containing the category semantic information according to the multi-scale features obtained from the feature extraction module; and
the prediction module is used for classifying and positioning the object according to the fused feature map obtained from the feature fusion module.

Optionally, the feature extraction module is constructed based on the designed DSC_Attention module, the two-dimensional convolution module Conv, the dynamic snake convolution module DySC, the Attention module and the SPP module, where the attention mechanism embedded in the DSC_Attention module and the Attention module adopts the optimal attention mechanism adaptive embedding strategy based on the deep reinforcement learning, and the initial default embedded attention mechanism module is the CPCA attention mechanism module.

Optionally, the adaptive enhancement modules include: 1) a deep reinforcement learning-based adaptive enhancement network for low-quality images, and 2) a feature extraction adaptive enhancement module of the multi-attention mechanism adaptively embedded network based on heatmaps and Double Deep Q-Network (DDQN).

Optionally, the feature fusion module includes the three DySC modules, the six DSCSP modules, the six SDFM modules and the three Upsample modules, where the bottom-up fusion path of the feature fusion module includes the following steps: the three SDFM modules are placed on the L13, L16 and L19 layers respectively; the three DSCSP modules are placed on the L14, L17 and L20 layers behind the three SDFM modules; the L12, L15 and L18 are the Upsample modules; and the top-down path includes the three groups of the same module structures: the L21-L23 layers are constructed by the one DySC module, the one SDFM module and the one DSCSP module, and the L24-L26 layers and the L27-L29 layers are also constructed in the same way.

The embodiment of the disclosure also provides a system for detecting the small objects under the complex scenarios, including a memory and a processor, where a computer program run by the processor is stored in the memory, and the computer program executes the method for detecting the small object in the complex scenario when the computer program is run by the processor.

The embodiment of the disclosure also provides a storage medium, where the computer program is stored on the storage medium, and the computer program executes the method for detecting the small objects under the complex scenarios at runtime.

Based on the investigation of the deep reinforcement learning, a dynamic snake convolutional neural network, an attention mechanism embedding, a multi-scale feature efficient fusion and a small object detection layer optimization, the disclosure designs the method for detecting the small objects under the complex scenarios based on a reinforcement learning adaptive enhancement, which realizes a high-precision identification and positioning of small objects, and at the same time has an adaptive ability of multiple complex scenarios. The disclosure has following technical effects.

In order to effectively extract the key features of the small objects with small scale and irregular distribution in complex environment images and improve a positioning accuracy and a detection sensitivity of the small objects, a complex small object feature extraction module (DSAM) based on the dynamic snake convolution and the attention mechanism is proposed. The module expands a receptive field by introducing the dynamic snake convolution, and enhances the ability of network to extract complex and irregular object features; and by pre-embedding CPCA attention mechanism module, the ability of feature extraction network to focus on small object details is improved, and an interference of complex background is suppressed and the detection sensitivity of the object is improved.

In order to achieve adaptive processing of low-quality images collected in diverse environments in a process of object detection, thereby improving detection accuracy and enhancing the generalization capability of the detection model, a DDQN-based adaptive enhancement module for object images in complex scenarios is designed. On the basis of four image enhancement processing sub-modules (image denoising, defogging, brightness enhancement and super-resolution), combined with a reinforcement learning optimization model based on the DDQN, the module adaptively selects the best combination of image enhancement methods to enhance input low-quality images.

In order to realize that the feature extraction module can adapt to the different types of the objects in the complex environments, a multi-attention mechanism adaptive embedded module of the feature extraction network based on the heatmap and the DDQN is proposed. The module adopts the optimal attention mechanism adaptive embedding strategy based on the deep reinforcement learning, and combines five alternative attention mechanism modules (a channel attention mechanism, a spatial attention mechanism, a coordinate attention mechanism, a CBAM attention mechanism and an EMA attention mechanism module) to realize an adaptive adjustment of the attention mechanism in the feature extraction module when dealing with different types of objects in other complex environments, so as to achieve better performance of focusing and extracting the key features of the objects.

Aiming at the multi-scale features of different levels obtained from the feature extraction module, in order to efficiently fuse shallow features with the detailed information and deep features with semantic information, a feature fusion module, MBiFPN, is proposed, which combines the dynamic snake convolution and the multi-attention mechanism. On the basis of BiFPN structure, the module introduces the dynamic snake convolution, a semantic and detail information fusion module embedded with the coordinate attention and the spatial attention mechanism, which enhances performance of multi-scale feature fusion, improves a focusing ability and a detection sensitivity of the model to the complex small objects by using the multi-attention mechanism, and reduces false detections and missed detections of the objects.

In order to further improve the positioning accuracy of an object detection model for the complex small objects and accelerate a convergence speed of a loss function, four new independent decoupling detection heads DSCSHead are designed to perform a positioning regression, identification and classification tasks of the object detection model. In DSCSHead, the dynamic snake convolution is introduced to improve the positioning accuracy of the complex small objects, and SIoU is used to improve a regression loss function to accelerate a model convergence.

### BRIEF DESCRIPTION OF THE DRAWINGS

In order to explain the embodiments of the present disclosure or the technical schemes in the prior techniques more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a schematic structural diagram of a device for detecting small objects under complex scenarios according to an embodiment of the present disclosure.

FIG. 2 is an internal structure of a DSC_Attention module.

FIG. 3 is a structural diagram of a DSAM module.

FIG. 4 is a structure of LIAENDRL.

FIG. 5 is a schematic diagram of action space of learning an optimal enhancement strategy for low-quality images based on DDQN.

FIG. 6 is a schematic diagram of a historical motion vector.

FIG. 7 is an MAMHD structure.

FIG. 8 is an action space diagram of optimal attention mechanism embedding strategy learning based on the DDQN.

FIG. 9 is a schematic diagram of a historical motion vector.

FIG. 10 is a structural diagram of an SDFM module.

FIG. 11 is a structural diagram of a DSCSP module.

FIG. 12 is a structural diagram of a DSCSHead module.

FIG. 13 is a schematic diagram of relevant parameters of an SIoU loss function.

### DETAILED DESCRIPTION OF THE EMBODIMENTS

In the following, the technical schemes in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure clearer and easier to understand, the present disclosure will be further described in detail with the attached drawings and specific embodiments.

### Embodiment 1

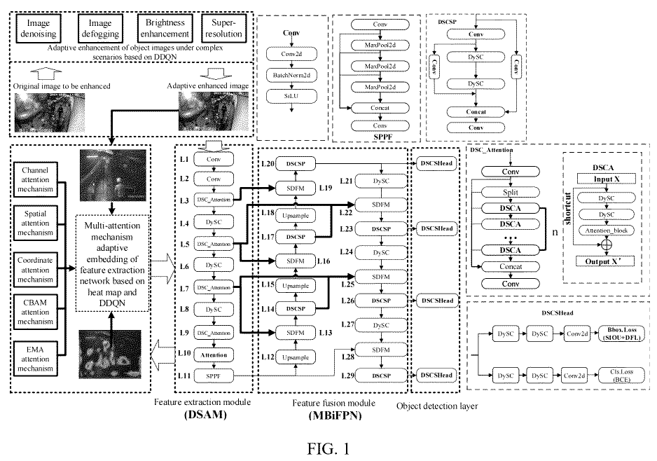

As shown in FIG. 1, the embodiment of the present disclosure provides a device for detecting small objects under complex scenarios, including:
an adaptive enhancement module, where the adaptive enhancement module is used for carrying out an adaptive enhancement pretreatment on low-quality images in images containing complex small objects, and carrying out a feature extraction enhancement on key features of different types of objects;
a feature extraction module DSAM, where the feature extraction module is used for adaptively excavating a multi-scale feature map representing key features of a small object from an enhanced image;
a feature fusion module MBiFPN, where the feature fusion module is used for fusing shallow feature maps containing detailed information of the object and deep feature maps containing category semantic information according to multi-scale features obtained from the feature extraction module; and
a prediction module, where the prediction module is used for classifying and positioning the object according to the fused feature maps obtained from the feature fusion module.

As an implementation of the embodiment of the present disclosure, a workflow of the adaptive enhancement module is as follows.

In order to improve an adaptability of an object detection model to different types of objects under different complex scenarios, an adaptive ability of a detection model is improved from two aspects: image enhancement preprocessing and a feature extraction. In terms of image preprocessing, an adaptive enhancement preprocessing module of a complex scenario object image is designed to carry out adaptive enhancement preprocessing on low-quality images under different complex scenarios. For the feature extraction and enhancement, it adopts the deep reinforcement learning-based adaptive embedding strategy for optimal attention mechanisms, a feature extraction adaptive enhancement module based on Heatmap and DDQN is proposed, and the attention mechanism which is more conducive to a key feature extraction for the different types of the objects is adaptively selected and embedded in the feature extraction module, thus improving a key feature extraction ability of the feature extraction module for the different types of the objects.

Adaptive enhancement preprocessing module for the complex scenario object image

In many complex environments, poor lighting conditions and limited performance of image acquisition equipment, obtained object images will face problems such as poor quality, blurred object, low resolution and inconspicuous visual features, which will seriously affect an accuracy of object detection. In order to adapt to the object detection of the low-quality images collected in different environments, improve the detection accuracy and generalization performance of the detection model, a low-quality image preprocessing module is designed. A low-quality image adaptive enhancement network based on deep reinforcement learning (LIAENDRL) adaptively adopts image enhancement strategies to improve the detection accuracy of the low-quality images in the different environments, transforms the low-quality images into high-quality images, and finally improves object feature extraction effects of the model for the low-quality images.

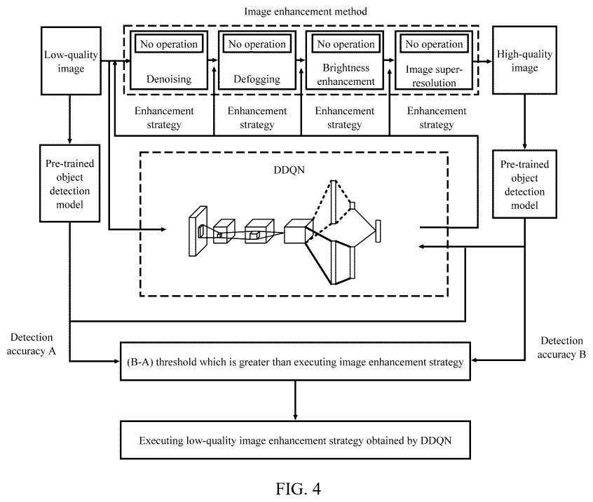

A structure of an image enhancement preprocessing module LIAENDRL designed by the embodiment of the present disclosure is shown in FIG. 4, and is described in detail as follows.
(1) An image enhancement method. In order to adapt to low-quality image enhancement under different scenarios, four image enhancement processing sub-modules are used for image denoising, defogging, brightness enhancement and super-resolution. Among them, the image denoising adopts a bilateral filtering algorithm to smooth the image while maintaining edge information of the object; the defogging adopts a dark channel prior defogging algorithm; the brightness enhancement adopts the URetinex-Net algorithm; and the image super-resolution adopts enhanced super-resolution generative adversarial networks (ESRGAN).
(2) An adaptive optimization of a low-quality image enhancement strategy based on DDQN. In face of the low-quality images, experienced experts and researchers usually manually select and adjust image enhancement algorithms and parameters according to their application scenarios. However, this method of manually adjusting the image enhancement algorithms and the parameters is difficult to adapt the object detection model to different application scenarios. For example, images in fog, smoke and other scenarios need to focus on the defogging, images under low-light or uneven-distribution scenarios need to focus on the brightness enhancement, and for low-resolution images, a super-resolution image reconstruction is needed to improve the object feature extraction effects. In this regard, the embodiment of the present disclosure uses the deep reinforcement learning method DDQN to learn the image enhancement strategy instead of manually selecting the image enhancement algorithms. As shown in FIG. 4, the low-quality image is input to the DDQN, and a strategy of image enhancement processing is output. An optimal algorithm combination is selected from four image enhancement processing methods to enhance the low-quality images and obtain the high-quality images that can effectively improve the accuracy of the object detection.

A network structure of the DDQN consists of three parts. The first part is a feature extraction layer, which consists of a three-layer CNN network. In the second part, there are two sub-networks composed of fully connected layers. One sub-network is a state-valued function network V(s;θ,β), where s stands for a state, θ stands for a CNN network parameter, and β is a parameter of the state-valued function network V. The other sub-network is an advantage function network A(s,a;θ,α) for predicting each action, where s represents the state, a represents an action to be performed, θ represents the CNN network parameter, and α is a parameter of the advantage function network A. The third part is to combine the results V(s;θ,β) and A(s,a;θ,α) of the two sub-networks in the second part to obtain a final state-action value Q, whose expression is:

Q(s,a;θ,α,B)=V(s;θ,β)+A(s,a;θ,α) (15)

Aiming at training and learning of an optimal enhancement strategy for the low-quality images based on the DDQN, through continuous contact with the environment, according to the current strategy of the model, an action with a largest value Q is selected as a next execution. In this process, an effect of an action execution is evaluated by using a specific action reward value given by the environment. Through an iterative optimization, a learning process is finally terminated under certain conditions, and an optimal strategy is output.

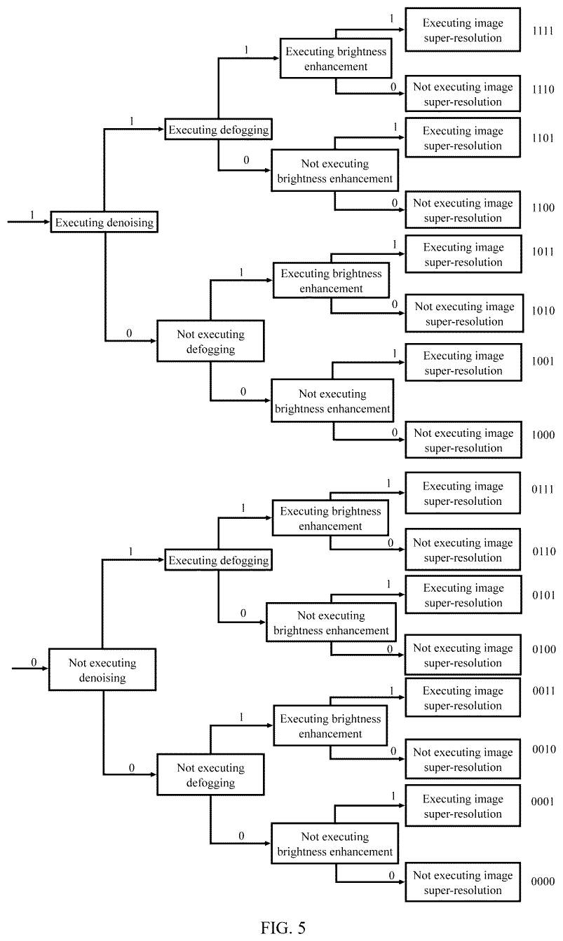

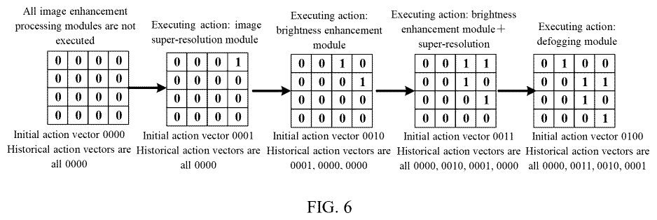

For an optimal enhancement strategy learning model for the low-quality images based on the DDQN designed by the embodiment of the present disclosure, a concrete construction of action space, state space, a reward function and a training optimization process is as follows.
\textcircled{1} The action space. The action space records all behavior sets which DDQN agents can take in an environment of a low-quality image processing. In the embodiment of the disclosure, four image processing modules are designed, and each module has two kinds of execution actions: processing with the module and no operation (not processing with the module), so a total of 16 actions can be executed. A schematic diagram of the action space is shown in FIG. 5. FIG. 6 shows recorded historical information of the last four selected actions, which constitutes a vector with a dimension of 4×4, denoted as h, and initialization time values are all 0. Every time a new vector h0 is constructed for the currently selected action, a dimension of this new vector is 1×4, and an action expressed by the vector corresponds to that in FIG. 5. Whenever updating the h, first scrolling down one step in a row dimension, and then assigning h0 to the first row of the current h. When the agent chooses to terminate the action, it means that the current state is the best according to the strategy, and no action is needed, which indicates that an iterative process of an action decision will end and the current action vector will be output as a final result.
\textcircled{2} The state space. The state represents information of the current environment and strongly affects a decision of the model on a next action, therefore the state space should contain enough comprehensive information. In a task of an adaptive enhancement of the low-quality images, a low-quality image I to be enhanced, an execution action a obtained from the optimal enhancement strategy learning model for the low-quality images based on the DDQN, and a corresponding reward signal r after the execution of the action will be input.
\textcircled{3} The reward function. The reward function is a key to guide the DDQN agent to find the best action selection strategy. In the embodiment of the disclosure, the agent adjusts the image enhancement processing strategy through a series of action sequences, and finally determines an optimal image enhancement module combination. Therefore, it is hoped that during the training process, strategy-enhanced images will be progressively optimized to be more conducive to improving the accuracy of object detection. At this time, the images enhanced according to the strategy will be input into a pre-trained object detection model, and the obtained object detection accuracy will be used as the reward function to measure benefits of an agent's action selection. Specifically, the object detection accuracy of the images enhanced by the current strategy is greater than that of the images enhanced by a previous strategy, which shows that a strategic action at this time is more conducive to an improvement of the object detection accuracy and should be rewarded; and on the contrary, it should be punished. By constructing an appropriate object function, a problem can be transformed into an object function optimization problem to maximize the reward, so that the agent can make an expected decision. The reward function for each action adopted by the embodiment of the disclosure is:

$${R}_{t} ( {s}_{t} , {s}_{t + 1} ) = sign ( Acc ( {O}_{t + 1} , {M}_{pre} ) - Acc ( {O}_{t} , {M}_{pre} ) ) \qquad ( 16 )$$

In the formula, Oₜ₊₁ represents an enhanced image after an execution of an action, Oₜ represents an enhanced image after the last action is executed, Mₚᵣₑ is an object detection model pre-trained for low-quality images without enhancement processing, and Acc (Oₜ₊₁, Mₚᵣₑ) represents an object detection accuracy obtained after Oₜ₊₁ input Mₚᵣₑ. A sign function takes the value of 1 or −1 according to whether a value of an internal expression is greater than 0. In order to make the number of choices as few as possible, different reward functions are needed for a termination action, as follows:

$${R}_{e} ( {s}_{1} , {s}_{t + 1} ) = \{ \begin{matrix}η & Acc ( {O}_{t + 1} , {M}_{pre} ) - Acc ( I , {M}_{pre} ) \geq τ \\ - η & Acc ( {O}_{t + 1} , {M}_{pre} ) - Acc ( I , {M}_{pre} ) < τ\end{matrix} \qquad ( 17 )$$

Where s_{I} represents an initial state, the low-quality image has not been enhanced, and I is the low-quality image; and when an object detection accuracy of an enhanced image after this action is executed is greater than an object detection accuracy of an original low-quality image by τ, a reward η will be obtained, otherwise the reward is −η.
\textcircled{4} The training optimization. A training process of the DDQN is summarized as follows: 100 low-quality images with low illumination, noise, blur and low resolution are selected as a training set, and then 100 high-quality images are selected to form training data. In addition, a way of “exploration and utilization” is introduced, and an object network and an experience playback pool are combined to improve a training efficiency and model performance. First, by establishing an experience playback pool R for model training, the state, action, reward and next state of each time step are recorded as an experience and stored. When an experience pool is mixed past and recent experiences, experience samples randomly sampled from R are of little relevance, and these experiences can be reused. Then, a training network Q(s,a;θ) is used to guide the action decision, and an object network Q⁻(s′,a′;θ′) is used to estimate the object Q value. The structure of the training network is the same as that of the object network. In order to reduce computation, parameters of the current training network should be obtained directly when the object network needs to be updated. An updating process of the training network is completed by minimizing a loss function of Equation (3-12):

$$L ( s , a \vert θ ) = {( y - Q ( s , a \vert θ ) )}^{2} \qquad ( 18 )$$

$$y = \{ \begin{matrix}r , & if done \\ r + {γmax}_{{a}^{′}} {Q}^{-} ( {s}^{′} , {a}^{′} \vert {θ}^{′} ) , & else\end{matrix} \qquad ( 19 )$$

In the formula, y represents a reward value, and when the action is not terminated, y is a superposition of a discount value of an immediate reward and a future return; and when the action is terminated, y is equal to the immediate reward, γ is a discount factor, which is used to determine a proportion of the future return in accumulated returns, and its value range is 0 to 1. In order to learn and gain more experience, we use the way of “exploration and utilization”, adopt a ε-greedy strategy to determine actions, perform optimal actions with a probability of 1−ε, and perform other actions with a probability of ε. The formula is as follows:

$$a = \{ \begin{matrix}arg max Q ( s , a ) , & 1 - ε probability \\ random ( a ) , & else\end{matrix} \qquad ( 20 )$$

### Feature Extraction Adaptive Enhancement Module

In order to improve the ability of the object detection network to focus and extract key features of different types of objects (scale, shape, etc.), a feature extraction adaptive enhancement module is designed, a multi-attention mechanism adaptive embedding network for a feature extraction module based on heatmaps and the DDQN (MAMHD), which can adaptively select the attention mechanism that is more conducive to the key feature extraction when facing the different types of the objects and embed the attention mechanism into the feature extraction network, thus improving the key feature extraction ability of the feature extraction module for the different types of the objects.

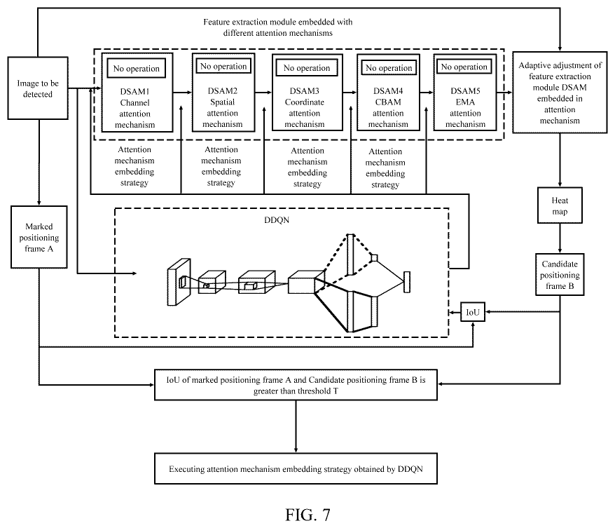

The MAMHD structure designed by the embodiment of the present disclosure is shown in FIG. 7, and is described in detail as follows.
(1) A multi-attention mechanism module. In order to adapt to the focus and the extraction of the key features of the different types of the objects under the complex scenarios, a attention mechanism module embedded in the feature extraction module is a CPCA attention mechanism module by default, and modules involved include: a DSC_Attention module and an attention module. In addition, many different types of attention mechanism modules are used as candidate modules for embedding the feature extraction module, including a channel attention mechanism module, a spatial attention mechanism module, a coordinate attention mechanism module, a CBAM attention mechanism module and an EMA attention mechanism module.
(2) An optimization of an attention mechanism embedding strategy based on the DDQN. Because there are obvious differences between objects to be detected under the complex scenarios, such as uneven scale and diverse shapes. Therefore, in the process of the feature extraction, the different types of the objects need to focus on different information. When facing different types of the object images, choosing an appropriate attention mechanism module can be more conducive to focusing and extracting the key features, thus improving the detection accuracy. In this regard, the embodiment of the disclosure adopts the deep reinforcement learning method DDQN to learn an optimal attention mechanism embedding strategy, so that when facing the different types of the object images, an adaptive attention mechanism module can be adaptively selected and embedded into the feature extraction module. As shown in FIG. 7, an image to be detected is input to the DDQN, and the attention mechanism embedding strategy is output. A module that is most suitable for extracting the key features from the image to be detected is selected from five kinds of the attention mechanism modules and embedded into the feature extraction module to enhance the focusing and extracting ability of the key features.

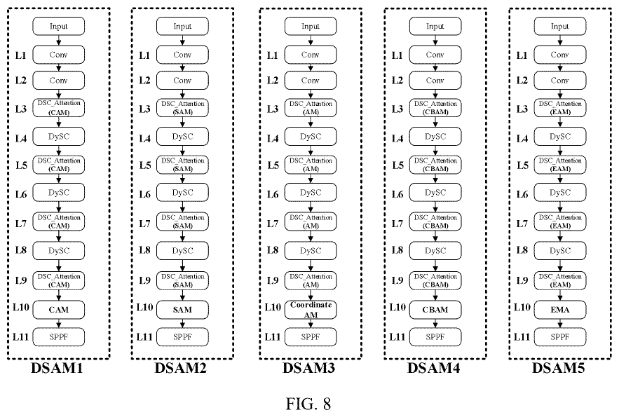

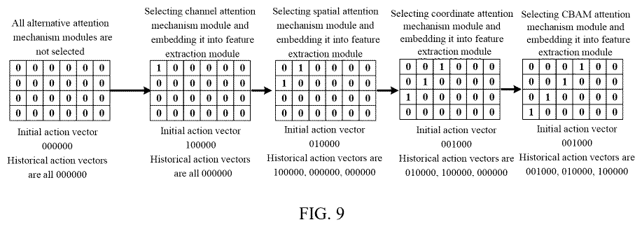

Here, the same DDQN network structure as that in LIAENDRL network is used, and a principle of training optimization process is the same, but main differences are the action space, the state space and the reward function.
\textcircled{1} The action space. The action space records all behavior sets that the DDQN agents can take in the environment. According to the embodiment of the disclosure, five attention mechanism embedding modules are designed, each module has two kinds of the execution actions: processing with the module and no operation (not embedding the module), and because one or all of the attention mechanism modules are finally selected, there are six kinds of actions. The schematic diagram of the action space is shown in FIG. 8. FIG. 9 shows the recorded historical information of the last four selected actions, which constitutes a vector with a dimension of 4×6, which is coded by one-hot, denoted as g, and the initialization time values are all 0. Every time the new vector h0 is constructed for the currently selected action, the dimension of this new vector is 1×6, and the action expressed by the vector corresponds to that in FIG. 8. Whenever updating the g, first scrolling down one step in the row dimension, and then assigning g0 to the first row of the current g. When the agent chooses to terminate the action, it means that the current state is the best according to the strategy, and no action is needed, which indicates that the iterative process of the action decision will end and the current action vector will be output as the final result.
\textcircled{2} The state space. The state represents the information of the current environment and strongly affects the decision of the model on the next action, so the state space should contain enough comprehensive information. In a task of adaptive learning of the optimal attention mechanism embedding strategy, an image I to be detected, an execution action b obtained from the optimal attention mechanism embedding strategy learning model based on the DDQN, and the corresponding reward signal r after the execution of the action will be input.
\textcircled{3} The reward function. The reward function is a key to guide the agent to find the best action selection strategy. In the embodiment of the disclosure, the agent adjusts the attention mechanism embedding strategy through a series of action sequences, and finally determines the optimal attention mechanism to be embedded in the feature extraction module. According to the embodiment of the disclosure, the heatmap of the image to be detected is obtained from the feature extraction module, and a candidate positioning frame of the object to be detected is determined based on this, and it is hoped that the feature extraction module embedded with the attention mechanism according to the strategy can be effectively adapted to the feature extraction of the different types of the objects in the training process, and more accurate key feature information can be obtained, thereby improving the detection accuracy. At this time, the image to be detected is input into the feature extraction module embedded in the corresponding attention mechanism according to the strategy, and the heatmap of the image is obtained, and the candidate positioning frame is determined in a range that a pixel value in the heatmap is more than σ times (σ∈[0.1,1]) of the maximum pixel value, and the IoU between the candidate positioning frame and a calibration frame of the image to be detected is calculated as the reward function to measure the benefit of agent action selection. Specifically, the feature extraction module embedded in the corresponding attention mechanism according to the current strategy can increase the IoU between the candidate positioning frame and the calibration frame of the image to be detected, which shows that the strategic action at this time is more conducive to the key feature extraction of the object to be detected and should be rewarded; and on the contrary, it should be punished. By constructing the appropriate object function, the problem can be transformed into the object function optimization problem to maximize the reward, so that the agent can make the expected decision. The reward function for each action adopted by the embodiment of the disclosure is:

$${R}_{t}^{AM} ( {s}_{t} , {s}_{t + 1} ) = sign ( IoU ( {Box}_{t + 1} , {Box}_{pre} ) - IoU ( {Box}_{t} , {Box}_{pre} ) ) \qquad ( 22 )$$

Where Boxₜ₊₁ represents the candidate bounding boxes of the target object to be detected, which are determined from the heatmaps of the image to be detected obtained by the feature extraction module after the current action is performed, Boxₜ represents the candidate bounding boxes of the target object to be detected, which were determined from the heatmaps of the image to be detected obtained by the feature extraction module following the execution of the previous action. Boxₚᵣₑ is the calibration frame of the image to be detected, and IOU(Boxₜ₊₁, BOXₚᵣₑ) stands for IoU between Boxₜ₊₁ and Boxₚᵣₑ. The sign function takes the value of 1 or −1 according to whether the value of the internal expression is greater than 0. In order to make the number of choices as few as possible, different reward functions are needed for the termination action, as follows:

$${R}_{e}^{AM} ( {s}_{1} , {s}_{t + 1} ) = \{ \begin{matrix}η & IoU ( {Box}_{t + 1} , {Box}_{pre} ) - IoU ( {Box}_{1} , {Box}_{pre} ) \geq T \\ - η & IoU ( {Box}_{t + 1} , {Box}_{pre} ) - IoU ( {Box}_{1} , {Box}_{pre} ) < T\end{matrix} \qquad ( 23 )$$

Where s_{I} represents the initial state, an initial attention mechanism in the feature extraction module has not been replaced, and Box_{I} represents the candidate positioning frame of the object to be detected determined by the heatmap of the image to be detected obtained from the feature extraction module embedded with a default attention mechanism; and when this action is executed, when IOU(Boxₜ₊₁, BOXₚᵣₑ)−IoU(Box₁, BOXₚᵣₑ) is greater than T, the reward η will be obtained, otherwise the reward will be −η.
\textcircled{4} The training optimization. The training process of the DDQN here is the same as that in the LIAENDRL network, which still introduces the way of “exploration and utilization” and combines the object network with the experience playback pool to improve the training efficiency and the model performance. A training data set is a training set consisting of 100 images of the different types of the objects under two scenarios (images of small objects that are easy to hide in coal mine underground and images of strip steel defects).

As an implementation of the embodiment of the present disclosure, a workflow of the feature extraction module DSAM is as follows.

In the feature extraction module DSAM proposed by the embodiment of the disclosure, an ability to accurately capture the features of complex small objects is enhanced by introducing a dynamic snake convolution, and at the same time, an adaptive attention to channel and spatial information is integrated in the feature extraction process of the complex small objects by embedding a channel priority convolution attention mechanism, so as to promote a rapid focus on important information channels and important spatial areas, better suppress an interference of background noise and enhance an expression ability of extracted features to the position and shape of the objects, and further improve an accurate positioning ability of object detection networks to different complex small objects.
(1) The dynamic snake convolution is introduced to enhance an ability of the feature extraction module to accurately capture the features of the complex small objects.

The complex small objects often show various positions and shapes, resulting in complex and irregular features in these object images. In most object detection models based on convolutional neural network (CNN), a fixed convolution kernel is adopted, which leads to a limited receptive field, which limits an ability of the model to capture a large amount of local information to some extent. Therefore, this conventional fixed convolution structure limits the extraction of complex and irregular features, which increases the difficulty of detecting the complex small objects and reduces a generalization ability of the model. In order to enhance an accurate detection ability of the object detection model based on the CNN for the complex small objects, it is very important to adaptively expand the receptive field, which will help the detection model learn a long-distance and irregular spatial relationship, and then enhance feature extraction performance of the detection model. In this regard, the embodiment of the disclosure introduces the dynamic snake convolution (DySC), and by learning a deformation from an input feature map and adaptively focusing on a tortuous and slender local structure of the object, features of an irregular structure are more accurately captured by expanding a local receptive field, and an ability of the detection model to adapt to different object geometries and sizes is improved, thus promoting the detection model to flexibly identify irregular features in complex small object images.

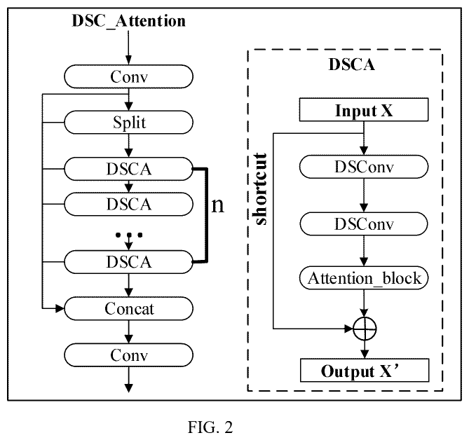

The embodiment of the disclosure introduces the DSC_Attention module into the feature extraction module to enhance an adaptive feature extraction ability of the complex small objects. FIG. 2 shows a structure of the DSC_Attention module. The DSC_Attention module is an improved module for a C2f module in YOLO series algorithms. A new DCSA module is designed to replace a Bottleneck module in the original C2f module. The DCSA module includes two DySC modules and one attention mechanism module.
(2) The attention mechanism is introduced to improve the detection model's ability to accurately locate the small objects.

Due to the small scale, irregularity and uneven distribution, the detection of the complex small objects is easily affected by background images and external noise, which leads to a reduction of an ability of many existing detection models to accurately locate the complex small objects. In recent years, many researchers have proposed various forms of attention mechanisms, such as Channel Attention and Spatial Attention, to improve an ability of the detection model to focus on the key features of the object. However, single consideration of the Channel Attention or the Spatial Attention only improves detection effects of conventional objects to a certain extent, but the detection effect is still not ideal in the face of the complex small objects that are easily affected by the environment. In this regard, the embodiment of the present disclosure introduces the channel priority convolution attention mechanism (CPCA) into the DSC_Attention module and the Attention module by default, so as to realize a dynamic distribution of attention weights in the channel and spatial dimensions while combining the Channel Attention and Spatial Attention mechanisms, promote the rapid focus on the important information channels and the important spatial areas, and improve the accurate positioning ability of the object detection network for the small objects. In addition, in order to further improve an adaptability of the feature extraction module designed in the embodiment of the disclosure when dealing with the feature extraction of the different types of the objects, the optimal attention mechanism adaptive embedding strategy based on the deep reinforcement learning is also designed to realize an adaptive adjustment of the attention mechanism module in the feature extraction module when dealing with the different types of the objects in other complex environments, so as to realize more ideal focus and extraction of the key features of the objects. In the feature extraction module, the attention mechanism module embedded in the DSC_Attention module and the Attention module by default is the CPCA attention mechanism module.
(3) Constructing the feature extraction module DSAM based on the dynamic snake convolution and the attention mechanism.

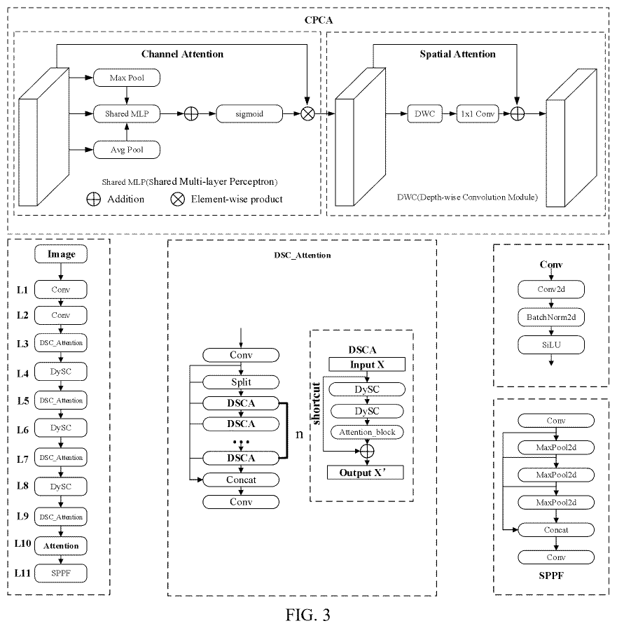

In order to effectively enhance an ability of the feature extraction network to accurately capture the location and shape features of the complex small objects, the embodiment of the present disclosure designs and constructs the feature extraction module DSAM based on the conventional Conv module, the DySC module, the DSC_Attention module, the Attention module and an SPP module, and a structure of this module is shown in FIG. 3. L1-L11 layers in the figure show sub-modules of the DSAM module, including 2 Conv modules, 3 DySC modules, 4 DSC_Attention modules, 1 Attention module and 1 SPP module. The attention mechanism module embedded in the DSC_Attention module and the Attention module by default is the CPCA attention mechanism module. The L3, L5, L7 and L11 layers in this module can output feature maps of different scales, which can be input into a feature fusion network MBiFPN for multi-scale feature fusion.

As an implementation of the embodiment of the present disclosure, a workflow of the feature fusion module MBiFPN is as follows.

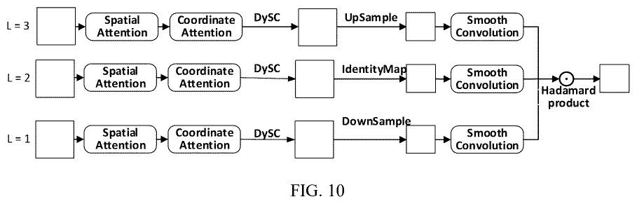

In order to make full and efficient use of feature information contained in the multi-scale feature map, which is beneficial to the classification, identification and location of the complex small objects, based on a BiFPN structure, a designed semantic and detail information fusion module (SDFM), a DSCSP module, a Upsample module and a dynamic snake convolution module are embedded, and a new feature fusion module MBiFPN is designed and constructed, which can effectively fuse the shallow feature maps containing the detailed information of the object and the deep feature maps containing the category semantic information, and improve a positioning sensitivity of the complex small objects.
(1) A semantic and detail information fusion module embedded with the coordinate attention and the spatial attention mechanism is introduced to enhance performance of multi-scale feature fusion. In order to make full and efficient use of the feature information contained in the multi-scale feature maps, which is beneficial to the object detection and identification, the SDFM module is designed and introduced into a BiFPN module to fuse different scale feature maps. A structure of the SDFM module is shown in FIG. 10. The figure shows an internal structure of the SDFM module, taking a fusion of three-layer feature maps with different scales as an example. Assume that a feature map of an M-mayor is

$$\{ {f}_{1}^{0} , {f}_{2}^{0} , … , {f}_{M}^{0} \} ,$$

where

$${f}_{m}^{0} ,$$

1≤m≤M represents the feature map of the M-layer. According to a structure diagram of the SDFM module shown in FIG. 10, firstly,

$${f}_{m}^{0}$$

is processed by the spatial attention mechanism and the coordinate attention mechanism modules to obtain a feature map

$${f}_{m}^{1}$$

containing local spatial information and global channel information, and then a dynamic snake convolution processing

$${f}_{m}^{1}$$

is used to reduce the number of channels and obtain a feature map

$${f}_{m}^{2} .$$

Then, the size of each feature map is readjusted to match a resolution of the feature map

$${f}_{m}^{2} ,$$

and its expression is as follows:

$${f}_{mn}^{3} = \{ \begin{matrix}{F}_{D} ( {f}_{n}^{2} , ( {H}_{m} , {W}_{m} ) ) & n < m \\ {F}_{I} ( {f}_{n}^{2} ) & n = m \\ {F}_{U} ( {f}_{n}^{2} , ( {H}_{m} , {W}_{m} ) ) & n > m\end{matrix} \qquad ( 27 )$$

In the formula, F_{I}, F_{D} and F_{U} respectively represent identity mapping of

$${f}_{n}^{2} ,$$

adaptive average pooling and bilinear interpolation operations, respectively, so as to match its resolution to Hₘ×Wₘ. On this basis, performing a smooth convolution operation on

$${f}_{mn}^{3}$$

by using a 3×3 convolution to obtain

$${f}_{mn}^{4} ,$$

and the expression is as follows:

$${f}_{mn}^{4} = {ρ}_{mn} ( {f}_{mn}^{3} ) \qquad ( 28 )$$

Where ρₘₘ represents a parameter of a smoothing operation, and

$${f}_{mn}^{4}$$

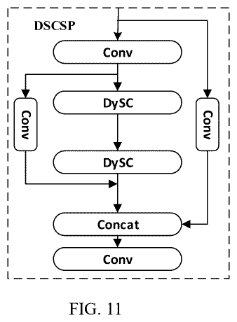

represents an n-th smooth feature map on the m-th layer. Finally, in order to further strengthen the integration of more object semantic information and object boundary detail information in the m-layer feature map, Hadamard product is used to process the M-layer feature map, and the expression is as follows:

$${f}_{m}^{5} = H ( [ {f}_{m 1}^{4} , {f}_{m 2}^{4} , … , {f}_{mN}^{4} ] ) \qquad ( 29 )$$

Where H(•) stands for a Hadamard product operation.
(2) The dynamic snake convolution is introduced to enhance the ability of the object feature extraction and improve a sensitivity to complex and irregular small object features. According to the embodiment of the disclosure, the DSCSP module is designed and constructed based on the conventional Conv module, the DySC module and a Concat module, and the module can enhance the ability of the object feature extraction by introducing the dynamic snake convolution, and at the same time, it can reduce the calculation amount and network complexity. A structure of the DSCSP module is shown in FIG. 11.
(3) Constructing a feature extraction module MBiFPN.

In order to realize the efficient fusion of the shallow feature maps containing the detailed information of the objects and the deep feature maps containing the category semantic information, and improve the sensitivity to the complex small object features, on the basis of the BiFPN structure, the embodiment of the present disclosure designs and constructs the new feature fusion module MBiFPN based on the conventional DySC module, the DSCSP module, the SDFM module and the Upsample module, and the structure of this module is shown in FIG. 1. A bottom-up fusion path of a MBiFPN network includes following steps: three SDFM modules are placed on L13, L16 and L19 layers respectively; three DSCSP modules are placed on L14, L17 and L20 layers behind the three SDFM modules; L12, L15 and L18 are Upsample modules; and a top-down path includes three groups of same module structures: L21-L23 layers are constructed by one DySC module, one SDFM module and one DSCSP module, and L24-L26 layers and L27-L29 layers are also constructed in the same way. After constructing two fusion paths from top to bottom and from bottom to top in the feature fusion module respectively through the above modules, based on a design idea of the BiFPN structure, the feature maps output from L5 and L7 layers in the embodiment of the present disclosure are respectively connected to L22 and L25 layers.

A multi-scale feature fusion module MBiFPN constructed by the embodiment of the disclosure can realize the efficient fusion of the multi-scale features, further enhance the sensitivity of the feature extraction of the complex small objects, and improve the identification and positioning accuracy of the small objects.

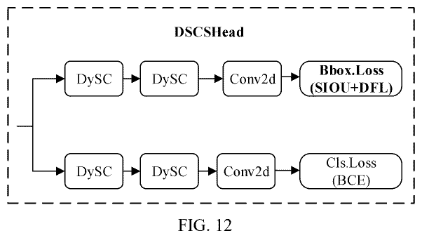

As an implementation of the embodiment of the disclosure, four DSCSHead object prediction branches are designed and constructed based on the output feature maps of L20, L23, L26 and L29 of the feature fusion module MBiFPN, and each branch is based on an independent decoupling detection head in a YOLOv8 series algorithm, and the dynamic snake convolution is introduced and a bounding box regression task loss function is improved, so as to improve the accuracy of the complex small object identification and accelerate a convergence. A structure of the designed DSCSHead module is shown in FIG. 12. When the original independent decoupling detection head is faced with the small object detection task disturbed by complex environmental noise, a small position deviation in a predicted small pixel object frame will adversely affect a calculation of a bounding box loss function, which will easily lead to a decrease of an identification accuracy. Moreover, in the face of small objects with little change in aspect ratio or proportion, a convergence rate of the loss function is not high, which further affects performance of the whole regression task. In order to overcome the above problems, the embodiment of the disclosure introduces the dynamic snake convolution and improves the bounding box regression task loss function, replaces a CIoU loss function with an SIoU loss function, and performs the bounding box regression task in combination with DFL; a BCE loss function is used for classification branch to deal with object classification tasks.

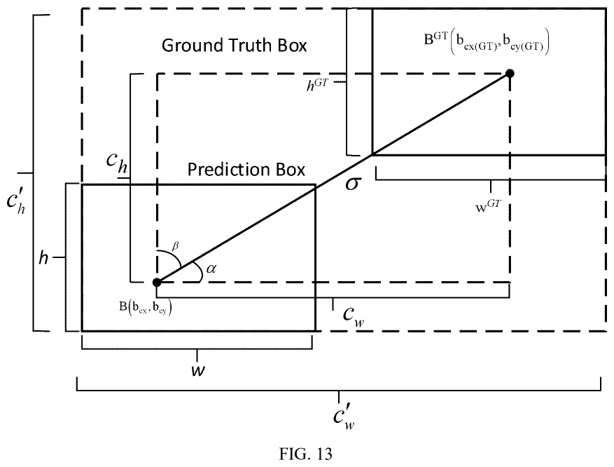

The SIoU considers four aspects of costs to construct the object loss function: Angle cost, Distance cost, Shape cost and IoU cost. FIG. 13 shows parameters related to the SIoU loss function.
(1) An expression of the Angle cost is as follows:

$${E}_{angle} = 1 - 2 \times {sin}^{2} ( arcsin ( {C}_{h} / σ ) - ( π / 4 ) ) \qquad ( 30 )$$

In the formula,

$$σ = \sqrt{{( {b}_{cx ( GT )} - {b}_{cx} )}^{2} + {( {b}_{cy ( GT )} - {b}_{cx} )}^{2}} \qquad ( 31 )$$

(2) An expression of the Distance cost is as follows:

$${E}_{distance} = 2 - {e}^{( {E}_{angle} - 2 ) \times {( {c}_{h} / {c}_{h}^{′} )}^{2}} - {e}^{( {E}_{angle} - 2 ) \times {( {c}_{w} / {c}_{w}^{′} )}^{2}} \qquad ( 32 )$$

(3) The Shape cost is defined as:

$${E}_{shape} = {( 1 - {e}^{- \frac{\vert w - {w}^{GT} \vert}{Max ( w , {w}^{GT} )}} )}^{θ} + {( 1 - {e}^{- \frac{\vert h - {h}^{GT} \vert}{Max ( h , {h}^{GT} )}} )}^{θ} \qquad ( 33 )$$

(4) The IoU cost is defined as:

$${E}_{IoU} = \frac{\vert B ⋂ {B}^{GT} \vert}{\vert B ⋃ {B}^{GT} \vert} \qquad ( 34 )$$

Where B and B^{GT} represent a real calibration frame and a prediction frame respectively.
(5) The SIoU Loss is defined as follows:

$${Loss}_{SIoU} = 1 - {E}_{IoU} + \frac{{E}_{distance} + {E}_{shape}}{2} \qquad ( 35 )$$

Based on the definition of the SIoU loss function, a calculation of distance cost takes into account an angle loss related to a real marker frame and the prediction frame, and introduces angle cost into the loss function, which is beneficial to calculate the distance cost between the marker frame and the prediction frame. In an initial stage of detection model training, the prediction frame and the marker frame usually do not intersect. By introducing the angle cost, the calculation of the distance between the two frames can be accelerated, thus achieving faster convergence of the whole regression task. To sum up, with an introduction of the angle cost, the SIoU loss function realizes a more comprehensive calculation of the loss function, and further improves a stability of loss function convergence, thus improving the regression accuracy and reducing prediction errors.

In order to overcome problems of low detection accuracy and poor model robustness in the complex environment, poor lighting conditions and low image quality caused by uneven scale and irregular visual features of the small objects under the complex scenarios, a new device for detecting the small objects under the complex scenarios is proposed, which can realize high-precision identification and positioning of the small objects and has the adaptive ability of multiple complex scenarios. The detection device includes following four aspects. (1) The complex small object feature extraction module based on the dynamic snake convolution and the attention mechanism effectively enhances a network's ability to extract complex and irregular object features, improves an ability to focus on the detailed features of the small objects while suppressing an interference of complex background, and improves the detection sensitivity of the small objects. (2) Image enhancement preprocessing and the feature extraction adaptive enhancement module based on the reinforcement learning firstly adopts the designed low-quality image adaptive enhancement network based on deep reinforcement learning, and adaptively selects the best combination of image enhancement methods to enhance input low-quality images; and then, the designed multi-attention mechanism adaptive embedding network for the feature extraction module based on the heatmaps and the DDQN is used, and the attention mechanism which is more conducive to key feature extraction for the different types of the objects is adaptively selected and embedded into the feature extraction module, so as to improve the ability of the feature extraction module to focus and extract the key features of the different types of the small objects. (3) A feature fusion module combining the dynamic snake convolution and the multi-attention mechanism can efficiently fuse shallow features containing the detailed information and deep features containing the semantic information, and improve the positioning sensitivity of the complex small objects. (4) The dynamic snake convolution and the SIoU are introduced to improve the detection head, which further improves the positioning accuracy of the object detection model for the complex small objects and accelerates the convergence speed of the loss function.

### Embodiment 2

The embodiment of the disclosure also provides a method for detecting the small objects under the complex scenarios, including following steps:
the adaptive enhancement module is used for carrying out the adaptive enhancement pretreatment on the low-quality images in the images containing the complex small objects, and carrying out the feature extraction enhancement on the key features of the different types of the objects;
the feature extraction module is used for adaptively excavating the multi-scale feature map representing the key features of the small object from the enhanced image;
the feature fusion module is used for fusing the shallow feature maps containing the detailed information of the object and the deep feature maps containing the category semantic information according to the multi-scale features obtained from the feature extraction module; and
the prediction module is used for classifying and positioning the object according to the fused feature maps obtained from the feature fusion module.

As an implementation of the embodiment of the present disclosure, the feature extraction module is constructed based on the designed DSC_Attention module, the two-dimensional convolution module Conv, the dynamic snake convolution module DySC, the Attention module and the SPP module, where the attention mechanism embedded in the DSC_Attention module and the Attention module adopts the optimal attention mechanism adaptive embedding strategy based on the deep reinforcement learning, and the initial default embedding attention mechanism module is the CPCA attention mechanism module.

As an implementation of the embodiment of the present disclosure, the adaptive enhancement module includes the low-quality image adaptive enhancement network based on the deep reinforcement learning and the feature extraction adaptive enhancement module based on the multi-attention mechanism adaptive embedding network of the heatmaps and the DDQN.

As an implementation of the embodiment of the disclosure, the feature fusion module includes three DySC modules, six DSCSP modules, six SDFM modules and three Upsample modules, where a bottom-up fusion path of the feature fusion module includes following steps: three SDFM modules are placed on L13, L16 and L19 layers respectively; three DSCSP modules are placed on L14, L17 and L20 layers behind the three SDFM modules; L12, L15 and L18 are the Upsample modules; and the top-down path includes three groups of the same module structures: L21-L23 layers are constructed by one DySC module, one SDFM module and one DSCSP module, and L24-L26 layers and L27-L29 layers are also constructed in the same way. After constructing two fusion paths from top to bottom and from bottom to top in the feature fusion module respectively through the above modules, based on the design idea of the BiFPN structure, the feature maps output from L5 and L7 layers in the embodiment of the present disclosure are respectively connected to L22 and L25 layers.

### Embodiment 3

The embodiment of the disclosure also provides a system for detecting the small objects under the complex scenarios, including a memory and a processor, where a computer program run by the processor is stored in the memory, and the computer program executes the method for detecting the small objects under the complex scenarios when the computer program is run by the processor.

### Embodiment 4

The embodiment of the disclosure also provides a storage medium, where the computer program is stored on the storage medium, and the computer program executes the method for detecting the small objects under the complex scenarios at runtime.

The above-mentioned embodiments only describe the preferred mode of the present disclosure, and do not limit the scope of the present disclosure. Under the premise of not departing from the design spirit of the present disclosure, various modifications and improvements made by ordinary technicians in the field to the technical schemes of the present disclosure should fall within the protection scope of the present disclosure.

What is claimed is:

1. A device for detecting small objects under complex scenarios, comprising:
an adaptive enhancement module, wherein the adaptive enhancement module is used for carrying out an adaptive enhancement pretreatment on low-quality images in images containing complex small objects, and carrying out a feature extraction enhancement on key features of different types of objects;
a feature extraction module, wherein the feature extraction module is used for adaptively excavating a multi-scale feature map representing key features of a small object from an enhanced image;
a feature fusion module, wherein the feature fusion module is used for fusing a shallow feature map containing detailed information of the object and a deep feature map containing category semantic information according to multi-scale features obtained from the feature extraction module; and
a prediction module, wherein the prediction module is used for classifying and positioning the object according to a fused feature map obtained from the feature fusion module.

2. The device for detecting the small objects under the complex scenarios according to claim 1, wherein the feature extraction module is constructed based on a designed DSC_Attention module, a two-dimensional convolution module Conv, a dynamic snake convolution module DySC, an Attention module and an SPP module, wherein an attention mechanism embedded in the DSC Attention module and the Attention module adopts an optimal attention mechanism adaptive embedding strategy based on deep reinforcement learning, and an initial default embedding attention mechanism module is a CPCA attention mechanism module.

3. The device for detecting the small objects under the complex scenarios according to claim 2, wherein the adaptive enhancement module comprises a low-quality image adaptive enhancement network based on the deep reinforcement learning and a feature extraction adaptive enhancement module based on a multi-attention mechanism adaptive embedding network of heatmaps and DDQN.

4. The device for detecting the small objects under the complex scenarios according to claim 3, wherein the feature fusion module comprises three DySC modules, six DSCSP modules, six SDFM modules and three Upsample modules, wherein a bottom-up fusion path of the feature fusion module comprises following steps: three SDFM modules are placed on L13, L16 and L19 layers respectively; three DSCSP modules are placed on L14, L17 and L20 layers behind the three SDFM modules; L12, L15 and L18 are Upsample modules; and a top-down path comprises three groups of same module structures: L21-L23 layers are constructed by one DySC module, one SDFM module and one DSCSP module, and L24-L26 layers and L27-L29 layers are also constructed in the same way.

5. A method for detecting the small objects under the complex scenarios, comprising following steps:
carrying out the adaptive enhancement pretreatment on the low-quality images in the images containing the complex small objects, and carrying out the feature extraction enhancement on the key features of the different types of the objects by an adaptive enhancement module;
adaptively excavating the multi-scale feature map representing the key features of the small object from the enhanced image by a feature extraction module;
fusing the shallow feature map containing the detailed information of the object and the deep feature map containing the category semantic information by a feature fusion module according to the multi-scale features obtained from the feature extraction module; and
classifying and positioning the object according to the fused feature map obtained from the feature fusion module by a prediction module.

6. The method for detecting the small objects under the complex scenarios according to claim 5, wherein the feature extraction module is constructed based on a designed DSC_Attention module, a two-dimensional convolution module Conv, a dynamic snake convolution module DySC, an Attention module and an SPP module, wherein an attention mechanism embedded in the DSC_Attention module and the Attention module adopts an optimal attention mechanism adaptive embedding strategy based on deep reinforcement learning, and an initial default embedding attention mechanism module is a CPCA attention mechanism module.

7. The method for detecting the small objects under the complex scenarios according to claim 6, wherein the adaptive enhancement module comprises the low-quality image adaptive enhancement network based on the deep reinforcement learning and the feature extraction adaptive enhancement module based on the multi-attention mechanism adaptive embedding network of the heatmaps and the DDQN.

8. The method for detecting the small objects under the complex scenarios according to claim 7, wherein the feature fusion module comprises the three DySC modules, the six DSCSP modules, the six SDFM modules and the three Upsample modules, wherein the bottom-up fusion path of the feature fusion module comprises the following steps: the three SDFM modules are placed on the L13, L16 and L19 layers respectively; the three DSCSP modules are placed on the L14, L17 and L20 layers behind the three SDFM modules; the L12, L15 and L18 are the Upsample modules; and the top-down path comprises the three groups of the same module structures: the L21-L23 layers are constructed by the one DySC module, the one SDFM module and the one DSCSP module, and the L24-L26 layers and the L27-L29 layers are also constructed in the same way.

9. A system for detecting the small objects under the complex scenarios, comprising a memory and a processor, wherein a computer program run by the processor is stored in the memory, and the computer program executes the method for detecting the small objects under the complex scenarios according to claim 5 when the computer program is run by the processor.

10. A storage medium, wherein the computer program is stored on the storage medium, and the computer program executes the method for detecting the small objects under the complex scenarios according to claim 5 at runtime.
